(19) United States
(12) Patent Application Publication
(10) Pub. No.: US 2009/0265682 A1
(43) Pub. Date: Oct. 22, 2009

(54) METHOD FOR TRANSFORMING DATA FROM A MODEL INTO A SECONDARY MODEL TO OPTIMIZE CODE GENERATION

(75) Inventors: Jonathan Limburn, Southampton (GB); Conor P. Beverland, Southampton (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/103,890

(22) Filed: Apr. 16, 2008

(51) Int. Cl. G06F 9/44

(52) U.S. Cl. 717/104

(57) ABSTRACT

A method for generating code includes receiving an eclipse modeling framework (EMF) model representing data in a structure from a source code application, parsing data from an EMF model, transforming parsed data into a secondary model, the secondary model being configured for a destination data structure, and generating code through java emitter templates (JET) based upon the secondary model.

### TECHNICAL FIELD

The present disclosure generally relates to the field of code generation, and more particularly to a method for transforming data from a model to a secondary model to optimize code generation.

### BACKGROUND

When utilizing existing code generation techniques with JET(Java Emitter Templates) and EMF(Eclipse Modeling Framework), a model is employed to represent the structure of the data. The model representing the structure of the data may be used to generate code. This data is held in a logical format to represent the source application, but is not utilized for complex code generation. This can lead to slow cumbersome code generation routines, which are difficult to maintain. The structure of the source model is still useful for some artifact generation and therefore its structure is not changed.

### SUMMARY

The present disclosure is directed to a method for generating code. In an embodiment, method for generating code includes receiving an eclipse modeling framework (EMF) model representing data in a structure from a source code application, parsing data from an EMF model, transforming parsed data into a secondary model, the secondary model being configured for a destination data structure, and generating code through java emitter templates (JET) based upon the secondary model.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for generating code.

### DETAILED DESCRIPTION

Reference will now be made in detail to the subject matter disclosed, which is illustrated in the accompanying drawings.

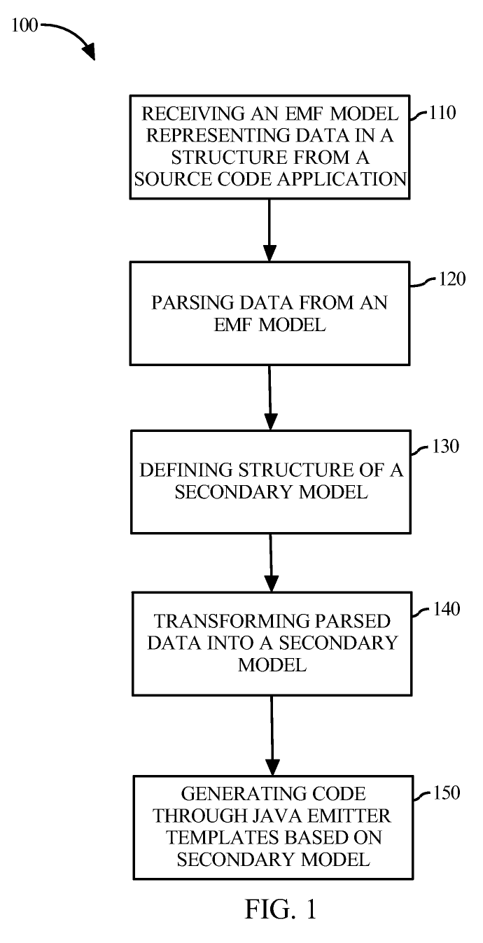

Referring to FIG. 1, a flow diagram illustrating a method 100 for generating code is shown. Method 100 for generating code may include receiving an eclipse modeling framework (EMF) model representing data in a structure from a source code application 110, parsing data from an EMF model 120, defining structure of a secondary model for code generation 130, transforming parsed data into a secondary model 130, the secondary model being configured for a destination data structure 140, and generating code through java emitter templates (JET) based upon the secondary model 150.

A method and system for model-driven development may introduce a secondary model from a first model that represents the same data in a different structure. This second structure may store the data in a logical format for the required generated code. This allows code generation to be more efficient as the structure of the secondary model allows the parser to act in a much more effective way, and allows vastly simplified JET templates to be used and maintained.

Conventional systems for generating code may employ an EMF model and execute an Eclipse transformation upon the EMF model to generate code using JET. Through an additional step in the middle of this process, the data is taken from the source EMF model and the structure of that data is transformed to suit a secondary model. It is then the structure of the data stored in this secondary model that is passed into the code generation routines.

Where as the source model's structure is dependant on the data in the source application, the secondary model structure suits the structure of the destination data, and can be designed to allow JET templates to generate code in a performant way. For example, tooling and runtime may be based around a deeply nested metamodel that is suitable for generating a User Interface. However as well as UI, implementation source code is also generated from the same metamodel. In that case, using the deeply nested structure would lead to complex and under performing JET templates that would iterate through the whole model at code generation time to ensure all the properties were added to the generated code. Instead we transform the model into a flat structure suitable for code generation allowing the JET transform to only loop through a small part of the model.

In summary, instead of a typical scenario where one model which represents data in a structure from a source application is being used to generate code, a second model is introduced which represents the target data. An additional transformation then takes place to restructure the data before the code is generated. The source models structure is optimized for storing data from the source application, and the new secondary model's structure is optimized to store that data in way most useful to the target application, in this case a JET template.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for generating code, comprising:
receiving a software development platform model representing data in a structure from a source code application;
parsing data from said software development platform model;
defining a flat structure of a secondary model for code generation;
transforming parsed data into the secondary model, said parsed data comprising a subset of said data within said software development model, said secondary model being configured for a destination data structure; and
generating code through an object oriented source code template based upon said secondary model.
